(19) United States
(12) Patent Application Publication
(10) Pub. No.: US 2011/0260674 A1
(43) Pub. Date: Oct. 27, 2011

(54) CARRYING CASE, PORTABLE ELECTRONIC DEVICE, AND ELECTRONIC APPARATUS USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/853,291

(22) Filed: Aug. 10, 2010

(30) Foreign Application Priority Data
Apr. 21, 2010 (TW) 99112579

(51) Int. Cl. H01M 10/46; H02J 7/00; B65D 85/00

(52) U.S. Cl. 320/101; 206/320; 320/108

(57) ABSTRACT

A carrying case used for accommodating a portable electronic device, includes an energy conversion unit for receiving sunlight, converting sunlight into electrical energy, and inductively charging the portable electronic device using the electrical energy when the portable electronic device is accommodated inside the carrying case.

### BACKGROUND

1. Technical Field

The present disclosure relates to carrying cases, and particularly to a carrying case for accommodating a portable electronic device.

2. Description of Related Art

When a user goes out with a portable electronic device, such as a mobile phone, the user may have to carry several batteries or a charger to provide enough electrical power, to power their device for a given period of time. This is inconvenient for the user.

Therefore, there is room for improvement in the art.

### BRIEF DESCRIPTION OF THE DRAWINGS

The components of the drawings are not necessarily drawn to scale, the emphasis instead being placed upon clearly illustrating the principles of the embodiment of a portable electronic device using a carrying case. Moreover, in the drawings, like reference numerals designate corresponding parts throughout the views.

FIG. 1 is an isometric, schematic view of an electronic apparatus according to an exemplary embodiment, including a portable electronic device and a carrying case for accommodating the portable electronic device.

FIG. 2 is a functional block diagram of the portable electronic device and the carrying case of FIG. 1.

### DETAILED DESCRIPTION

Embodiments of the present disclosure will now be described in detail with reference to the drawings.

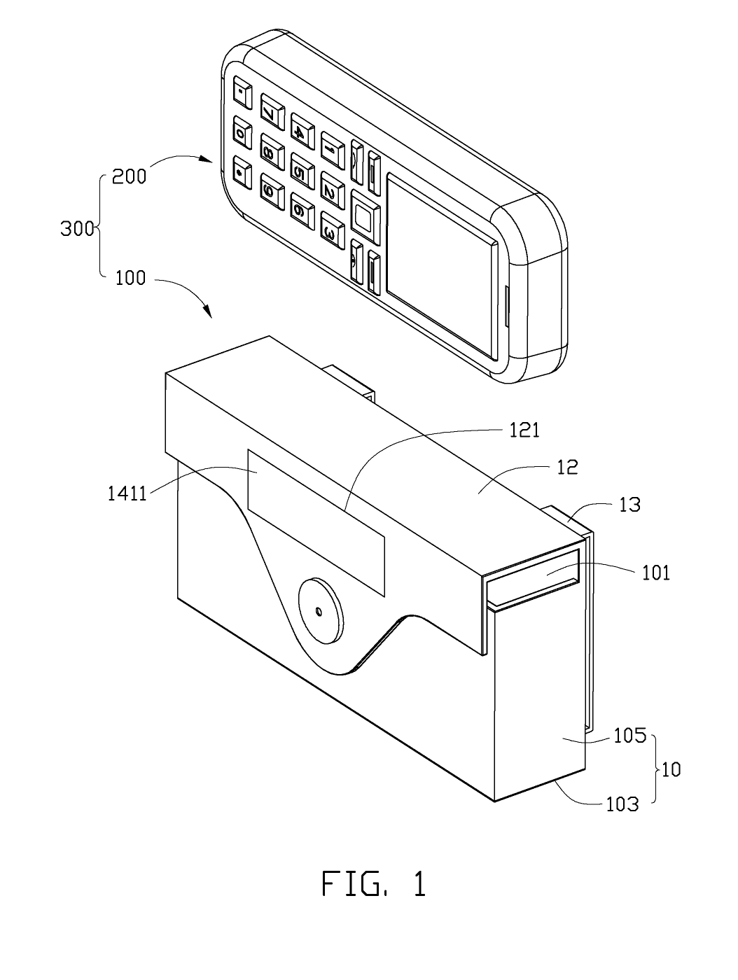

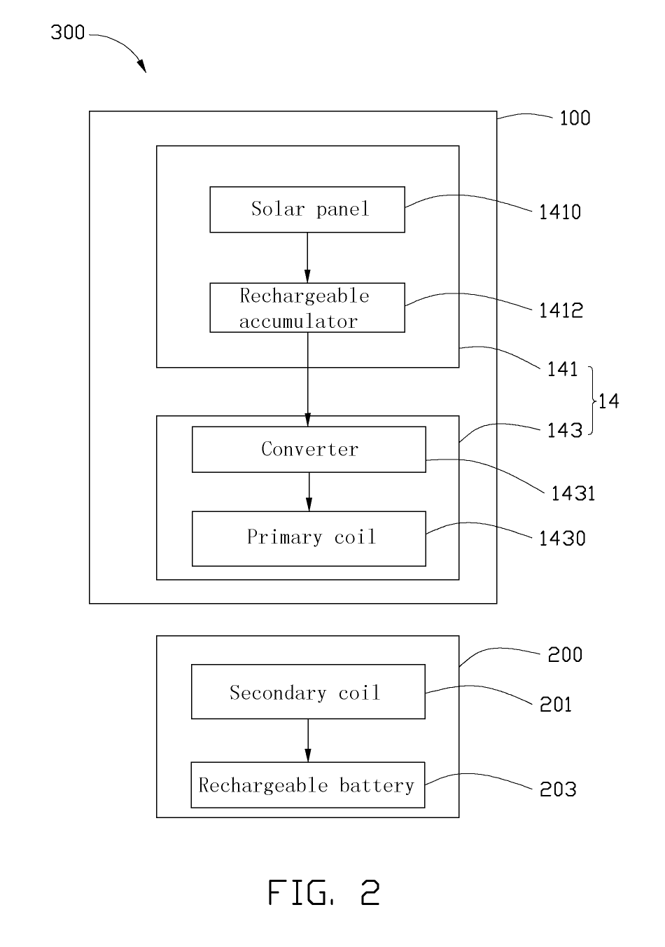

Referring to FIGS. 1 and 2, an electronic apparatus 300 according to an exemplary embodiment are illustrated. The electronic apparatus 300 includes a portable electronic device 200 and a carrying case 100 for accommodating the portable electronic device 200. The carrying case 100 is further used for charging the portable electronic device 200. In this embodiment, the portable electronic device 200 is a mobile phone, and the carrying case 100 is a case especially made for carrying the mobile phone. In other embodiments, the portable electronic device 200 can be a portable media player, and the carrying case 100 is a case especially made for the portable media player.

The carrying case 100 includes a housing 10, a cover 12, two belt loops 13, and an energy conversion unit 14. The housing 10 is configured for accommodating the portable electronic device 200. The energy conversion unit 14 is received in the cover 12. The two belt loops 13 are set on the outer surface of the housing 10.

The housing 10 includes a bottom wall 103 and a side wall 105. The side wall 105 connects to the bottom wall 103 to define a receiving compartment 101. The receiving compartment 101 is configured for receiving the portable electronic device 200.

The cover 12 is configured for covering the receiving compartment 101. The cover 12 extends beyond one edge of the side wall 105. A receiving recess 121 is defined in the cover 12. The receiving recess 121 is configured for receiving the energy conversion unit 14.

The two belt loops 13 are set on the outer surface of the side wall 105. The two belt loops 13 are configured for detachably attached the carrying case 100 to another object such as a belt of a user. The number of the belt loop 13 is not limited to two; it may be one or more than two.

The energy conversion unit 14 is received in the receiving recess 121. The energy conversion unit 14 is configured for receiving sunlight, converting sunlight into electrical energy, and charging the portable electronic device 200 using the electrical energy when the portable electronic device 200 is accommodated inside the receiving compartment 101. The energy conversion unit 14 includes a photoelectric conversion subunit 141 and a charging subunit 143. The photoelectric conversion subunit 141 is configured for receiving sunlight and converting sunlight into the electrical energy. The charging subunit 143 is configured for charging the portable electronic device 200 using the electrical energy when the portable electronic device 200 is accommodated inside the receiving compartment 101.

The photoelectric conversion subunit 141 includes a solar panel 1410 and a rechargeable accumulator 1412. The solar panel 1410 includes a receiver 1411 for receiving sunlight. The solar panel 1410 is received in the receiving recess 121. The receiver 1411 is exposed so that it may receive sunlight. In other embodiments, the cover 12 can further include a transparent casing (not shown). The transparent casing covers the receiving recess 121 to protect the solar panel 1410, and sunlight can irradiate the receiver 1411 after passing through the transparent casing.

The rechargeable accumulator 1412 is electrically connected to the solar panel 1410 and is charged by the solar panel 1410. The rechargeable accumulator 1412 is embedded into the housing 10. In this embodiment, the rechargeable accumulator 1412 is embedded into the bottom wall 103 of the housing 10. In other embodiments, the rechargeable accumulator 1412 can be embedded into other walls of the housing 10, or be embedded into the cover 12.

The charging subunit 143 is received in the receiving recess 121 and is further disposed behind the solar panel 1410. The charging subunit 143 includes a primary coil 1430 and a converter 1431 electrically connected to the primary coil 1430.

The converter 1431 is configured for converting direct current (DC) voltage from the photoelectric conversion subunit 141 into alternating current (AC) voltage, and powering the primary coil 1430. The primary coil 1430 produces an electromagnetic field when the AC voltage is applied to it.

The portable electronic device 200 includes a secondary coil 201 and a rechargeable battery 203. When the portable electronic device 200 is accommodated inside the receiving compartment 101, the secondary coil 201 is next to the primary coil 1430 for coupling with the primary coil 1430. Thus, the primary coil 1430 and the secondary coil 201 forms a transformer for charging the rechargeable battery 203. The rechargeable battery 203 is recharged by the charging subunit 143 when the primary coil 1430 and the secondary coil 201 are coupling with each other.

When the AC voltage from the converter 1431 flows in the primary coil 1430, the primary coil 1430 produces an electromagnetic field which induces a current in the secondary coil 201, and the secondary coil 201 generates AC voltage accordingly. The AC voltage from the secondary coil 201 is used to charge the rechargeable battery 203. Thus, when the portable electronic device 200 is accommodated inside the receiving compartment 101, the rechargeable battery 203 of the portable electronic device 200 can be charged by induction between the primary coil 1430 and the secondary coil 201.

As discussed, the carrying case 100 can convert sunlight into electrical energy by the solar panel 1410, store the electrical energy by the rechargeable accumulator 1412, and charge the portable electronic device 200 though induction when the portable electronic device 200 is received in the carrying case 100. Thus, the carrying case 100 can utilize “green” energy, and is environmentally friendly. Therefore, the need for the user to carry extra batteries or a charging cord for the portable electronic device 200, is eliminated.

In other embodiments, the rechargeable accumulator 1412 can be removed. The electrical energy generated by the photoelectric conversion subunit 141 is directly provided to the charging subunit 143.

In other embodiments, the receiving recess 121 may be located on any position of the carrying case 100 as long as the solar panel 1410 can receive sunlight.

In other embodiments, the charging subunit 143 can be located on any position the carrying case 100 as long as the primary coil 1430 is next to the secondary coil 201 to form a tramsformer when the portable electronic device 200 is received in the carrying case 100.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation to encompass all such modifications and similar arrangements.

What is claimed is:

1. A carrying case used for accommodating a portable electronic device, the carrying case comprising an energy conversion unit for receiving sunlight, converting sunlight into electrical energy, and inductively charging the portable electronic device using the electrical energy when the portable electronic device is accommodated inside the carrying case.

2. The carrying case of claim 1, wherein the energy conversion unit comprises a photoelectric conversion subunit and a charging subunit, the photoelectric conversion subunit is configured for receiving sunlight and converting sunlight into electrical energy, the charging subunit is configured for charging the portable electronic device using the electrical energy when the portable electronic device is accommodated inside the carrying case.

3. The carrying case of claim 2, wherein the charging subunit comprises a primary coil and a converter electrically connected to the primary coil, the converter is configured for converting a direct current (DC) voltage from the photoelectric conversion subunit into an alternating current (AC) voltage, the primary coil is configured for producing an electromagnetic field according to the AC voltage.

4. The carrying case of claim 3, wherein the portable electronic device comprises a secondary coil and a rechargeable battery, the secondary coil is configured for inducing a current according to the electromagnetic field, and for generating another AC voltage accordingly which is used for charging the rechargeable battery.

5. The carrying case of claim 2, wherein the photoelectric conversion subunit comprises a solar panel comprising a receiver for receiving sunlight, the solar panel is received in the carrying case, the receiver is exposed to receive sunlight, the solar panel is configured for converting sunlight into electrical energy.

6. The carrying case of claim 5, wherein the photoelectric conversion subunit further comprises a rechargeable accumulator, the rechargeable accumulator is electrically connected between the solar panel and the charging subunit, the rechargeable accumulator is charged by the solar panel and supply power to the charging subunit.

7. The carrying case of claim 6, further comprising:
a housing, the housing comprising a bottom wall and a side wall connected to the bottom wall to define a receiving compartment, the receiving compartment configured for accommodating the portable electronic device; and
a cover for covering the receiving compartment, the cover defining a receiving recess for receiving the solar panel.

8. The carrying case of claim 7, wherein the rechargeable accumulator is received in the receiving recess and disposed behind the solar panel.

9. A portable electronic device operable to be accommodated inside a carrying case, the portable electronic device is inductively charged when the portable electronic device is accommodated inside the carrying case.

10. The portable electronic device of claim 9, wherein the carrying case comprises a photoelectric conversion subunit and a charging subunit, the photoelectric conversion subunit is configured for receiving sunlight and converting sunlight into electrical energy, the charging subunit is configured for charging the portable electronic device using the electrical energy when the portable electronic device is accommodated inside the carrying case.

11. The portable electronic device of claim 10, wherein the charging subunit comprises a primary coil and a converter electrically connected to the primary coil, the converter is configured for converting a direct current (DC) voltage from the photoelectric conversion subunit into an alternating current (AC) voltage, the primary coil is configured for producing an electromagnetic field according to the AC voltage.

12. The portable electronic device of claim 11, wherein the portable electronic device comprises a secondary coil and a rechargeable battery, the secondary coil is configured for inducing a current according to the electromagnetic field, and for generating another AC voltage accordingly which is used for charging the rechargeable battery.

13. The portable electronic device of claim 10, wherein the photoelectric conversion subunit comprises a solar panel comprising a receiver for receiving sunlight, the solar panel is received in the carrying case, the receiver exposes to the air to receive sunlight, the solar panel is configured for converting sunlight into the electrical energy.

14. The portable electronic device of claim 13, wherein the photoelectric conversion subunit further comprises a rechargeable accumulator, the rechargeable accumulator is electrically connected between the solar panel and the charging subunit, the rechargeable accumulator is charged by the solar panel and supplies power to the charging subunit.

15. An electronic apparatus, comprising:
a carrying case, the carrying case comprising a photoelectric conversion subunit for converting solar energy into electric energy, a converter for converting the electric energy into an alternating current (AC) voltage, and a primary coil for producing an electromagnetic field according to the AC voltage; and
a portable electronic device, the portable electronic device comprising a secondary coil and a rechargeable battery, the secondary coil is configured for inducing a current according to the electromagnetic field, and for generating another AC voltage accordingly which is used for charging the rechargeable battery.

16. The electronic apparatus of claim 15, wherein the photoelectric conversion subunit comprises a solar panel comprising a receiver for receiving sunlight, the solar panel is received in the carrying case, the receiver exposes to the air to receive sunlight, the solar panel is configured for converting sunlight into the electrical energy.

17. The electronic apparatus of claim 16 wherein the carrying case comprises:
a housing, the housing comprising a bottom wall and a side wall connected to the bottom wall to define a receiving compartment, the receiving compartment configured for accommodating the portable electronic device; and
a cover for covering the receiving compartment, the cover defining a receiving recess for receiving the solar panel.
